(19) United States
(12) Patent Application Publication
(10) Pub. No.: US 2012/0179786 A1
(43) Pub. Date: Jul. 12, 2012

(54) MANAGING MEDIA CONTENT STREAMED TO USERS VIA A NETWORK

(75) Inventor: Thyagarajan NANDAGOPAL, Edison, NJ (US)

(73) Assignee: Alcatel-Lucent USA Inc.

(21) Appl. No.: 12/986,375

(22) Filed: Jan. 7, 2011

(51) Int. Cl. G06F 15/16

(52) U.S. Cl. 709/219

(57) ABSTRACT

A method for managing media content streamed to users via a network includes streaming a media content file via the network to a media player for playing the media content file. When the media content file is played by a user, a media mark associated with the played media content file is created to identify a section of the played media content file which is of interest to the user. The media mark includes a start indicator, a stop indicator and a content identifier. The media mark is stored. It may be stored locally, or at a store included in the network, or at the content provider, or in any combination of these.

### FIELD OF THE INVENTION

The present invention relates to a method and apparatus for managing media content streamed to users via a network.

### BACKGROUND

The explosion of video use over the Internet has led to a proliferation of video sharing sites. One well known video sharing site is YouTube™ in which a user selects a video of interest. The video stream is then downloaded via the network to a media player which the user operates to play the chosen content. There tend to be multiple versions of the same event available on a video sharing website. For example, there may be clips which are identical but with different decoding rates, clips of different durations or records of the same event but taken from different viewpoints. For example, if a soccer match contains a goal-scoring event, there will be tens of clips that highlight the same event but they will not cover the entire event equally.

It can prove difficult for a user to find the most appropriate video clip from the numerous possibilities. A viewer must click through multiple clips before they are able to find a version they particularly like. If ratings are a feature of the video sharing website, then the user may rate the chosen clip highly so as to aid other users. The need to explore numerous clips to find the most suitable one wastes many users' time. This process also wastes bandwidth as the network streams effectively unwanted content and this wasted bandwidth must be paid for by the content provider. The content provider must also store multiple similar clips uploaded by individual users who might feel that the current clips on the content provider are deficient in some way, leading to additional storage requirements at the content server.

When a user selects a clip to watch, the video stream loads from the beginning of the clip. To view a part of the clip which is of particular interest, the user is able to skip to another part of the stream, for example, by sliding an indicator along a time bar included in the media player user interface. When the user skips ahead, any part of the video file that has already been downloaded is discarded, even if it has not been played, and the content server then begins to serve from the user-selected part of the video clip. Download continues at a faster pace than the user views the content. Thus, if the user stops watching at a certain point, the additional part of the content that was downloaded is also wasted.

In another approach, a selected part may be extracted from the origina clip by the content owner or content provider and made available as another separate clip. However, this is not necessarily a part of the clip that is of interest to users.

### BRIEF SUMMARY

According to one aspect of the invention, a method for managing media content streamed to users via a network includes streaming a media content file via the network to a media player for playing the media content file. When the media content file is played by a user, a media mark associated with the played media content file is created to identify a section of the played media content file which is of interest to the user. The media mark includes a start indicator, a stop indicator and a content identifier. The media mark is stored. It may be stored locally, or at a store included in the network, or at the content provider, or in any combination of these.

The media content file may be a video file, an audio file, a presentation file or a combination of different media types. Any suitable media player may be used to play the media content file. For example, the media player could be an application installed in user equipment; an application incorporated in a web browser used by the user to access content on the network; an application included in a web page; or a combination of these approaches.

A media mark is a three-tuple as it includes at least: <content-id, start indicator, stop indicator> but this may be augmented so that the media mark includes additional descriptors, for example, to provide additional content identification. The creation of a media mark may enable streaming of content to be more efficiently managed. For example, as the section of a video clip, say, is identified by the media mark as being of particular interest, future requests for the content to be played, whether by the same user or by another, may be met by only streaming; the content making up that section. Any parts of the media content file prior to that n or following it are not streamed. Thus bandwidth and related costs are limited to content that is more likely to be that required by the person making the request to play it. Also, only that section identified by the media mark need be held for easy accessibility for a user, potentially reducing storage requirements and costs.

By creating a media mark, a user may in effect generate an extract of the original media content file. This may be useful for the user wanting to play the particular section of interest again in future, alert friends to that section or, where a recommendation system is provided in a social network, identify with more precision the part which is most of interest. Also, by creating a media mark, a user is able to specify where the section of interest should end, whereas previously, the user would need to manually stop playback each time unless the clip is allowed to run to its end. Multiple media marks may be specified for the same content. A media server from which the media content file is served may be limited to streaming content defined only by these media marks.

In one embodiment, the user operates a selector associated with the media player to create at least part of the media mark. For example, the media player could include a button to allow the user to select the start and stop indicators, with the content identifier being available from the media server.

In one embodiment, at least part of the media mark is automatically created using information from user behavior as the user plays the media content file. For example, the content provider may detect which part or parts of a clip a user plays and uses this to create start and stop indicators.

In one embodiment, a media mark may be created including the user making specific selections of the start and/or stop indicators but additionally, the same or a different media mark may be automatically created.

In an embodiment of the invention, a social tagging scheme allows multiple users to jointly share their media marks for a given content. By cataloguing these media marks, the media content server may determine the most popular media marks, and serve them to users, instead of storing the different pieces of content. Thus, it produces savings for the content provider, as well as providing an augmented interface for users to share and disseminate content.

In one embodiment, the stored media mark is used to select a section of the media content file to be prevented from being made available to a user. This may be useful, for example, in parental controls or other content control mechanisms, allowing advanced customization. For example, parental controls may include a mechanism using media marks in which the media marks identify content to be excluded, and the content provider streams the content omitting the parts identified by the media marks.

The start and stop indicators of the media mark may, for example, be specified in terms of the number of bytes from the start or end of the media clip. The start and stop indicators of the media mark may, for example, be specified in terms of time, for example, by the number of seconds from the beginning or end of the media clip.

According to another aspect of the invention, apparatus for managing media content streamed to a user via a network, including: a media player application for playing media content files streamed via the network from a content provider; a selector for creating a media mark associated with a streamed media content file played by the media player, the media mark identifying a part of a media content file which is of interest to the user and the media mark including a start indicator, a stop indicator and a content identifier; and a store for storing the media mark at the network.

### BRIEF DESCRIPTION OF THE DRAWINGS

Some embodiments of the present invention will now be described by way of example only, and with reference to the accompanying drawings, in which:

FIG. 1 schematically illustrates a media player interface for use with the invention;

FIG. 2 is a schematic flowchart showing steps in creating media marks;

FIG. 3 schematically illustrates aggregation of media marks;

FIG. 4 is a schematic flowchart of a ranking algorithm; and

FIG. 5 schematically illustrates apparatus in accordance with the invention.

### DETAILED DESCRIPTION

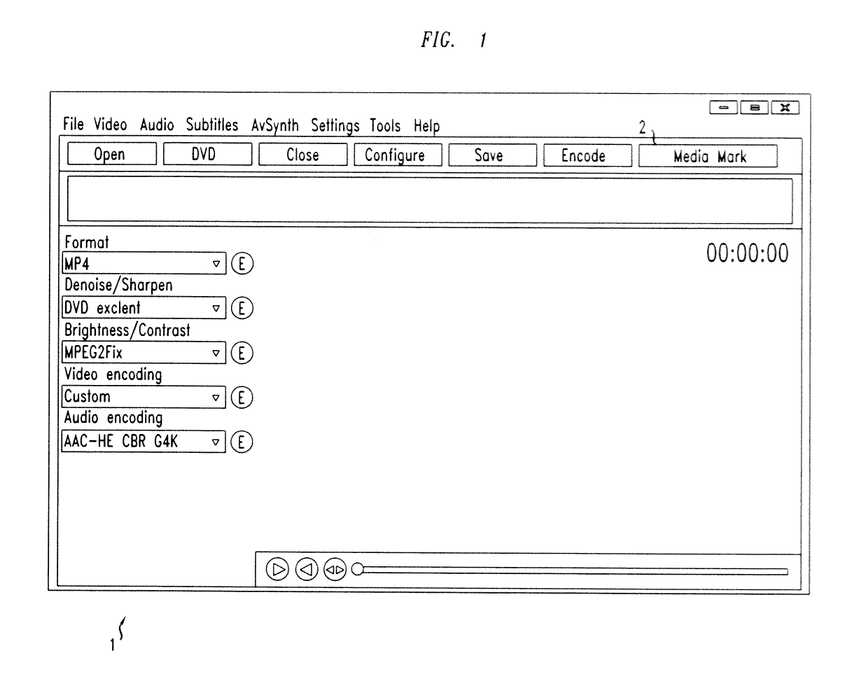

With reference to FIG. 1, a media player 1 includes various user pen controls including a ‘media-mark button’ 2.

To create a media mark, the user selects a media content file identified by ‘content-id’ at the start 3 of the procedure, as shown in FIG. 2. The user then selects playback or skip to go to the start of the section to be identified and pauses the media clip. The user then selects the media mark button 2 at 4 to indicate the start of the media mark. The user then continues playback or skips to the desired stop point 5, pauses the media clip again, and again selects the media-mark button 2 to indicate stop of the media-mark. This creates a meta-tile which includes the three-tuple describing the media mark at 6. The media mark is stored locally at 7 and also sent to content provider at 8.

The media-mark may be sent as an URL in the following format: http:/www.example.com/video=CONTENTID?num_marks=x&start1=s1&stop1=t1&start2=s2&stop2=t2& . . . &startx=sx&stopx=tx

If the content-id is globally unique, then the three-tuple description of the media-mark is sufficient for local storage. However, if the content-id space is not globally unique, then the content provider identifier, for example, the URL of the content provider, may also be stored locally as part of the media mark.

The process may be repeated if additional media marks are required for the same content, shown at 9. When all the required media marks have been created and stored, the procedure ends at 10.

A content provider or content server is the service provider who stores and streams media to end users and pays for storage, computing (such as transcoding), and bandwidth resources for streaming the content. Content providers have adopted a technique whereby they stream only a few seconds of buffered data from the current viewing point of a user. For example, if the user is watching a video at the 3 min 10 sec mark, the content provider will not send more than 15 seconds worth of data, that is, up to the 3 min 25 sec mark. This “adaptive-lookahead” technique may be used to implement implicit media mark creation by the content provider.

A content provider knows the starting point of a content clip, that is, if the user skips ahead to a particular playback point to begin watching, based on feedback from the media player. The content provider also knows automatically when a user navigates away from this media clip, for example, by the user closing the player or selecting another clip to play. The amount of data sent to the user using the adaptive look-ahead method allows the provider to determine the stop-point of the clip. This thus automatically creates a media mark without requiring active user input. While the implicit media mark so created may not reflect actual user viewing, it provides a better indicator of user interest than merely treating the entire clip as part of the user's interest profile as has previously been done.

When the user selects a particular media mark, which may be stored locally or at the content provider, for example, the media content associated with the ‘content-id’ is identified, and the content provider serves content from the start point and stops sending data past the stop-point. The user has the option of continuing playback of the remaining clip or skipping to another portion of the clip.

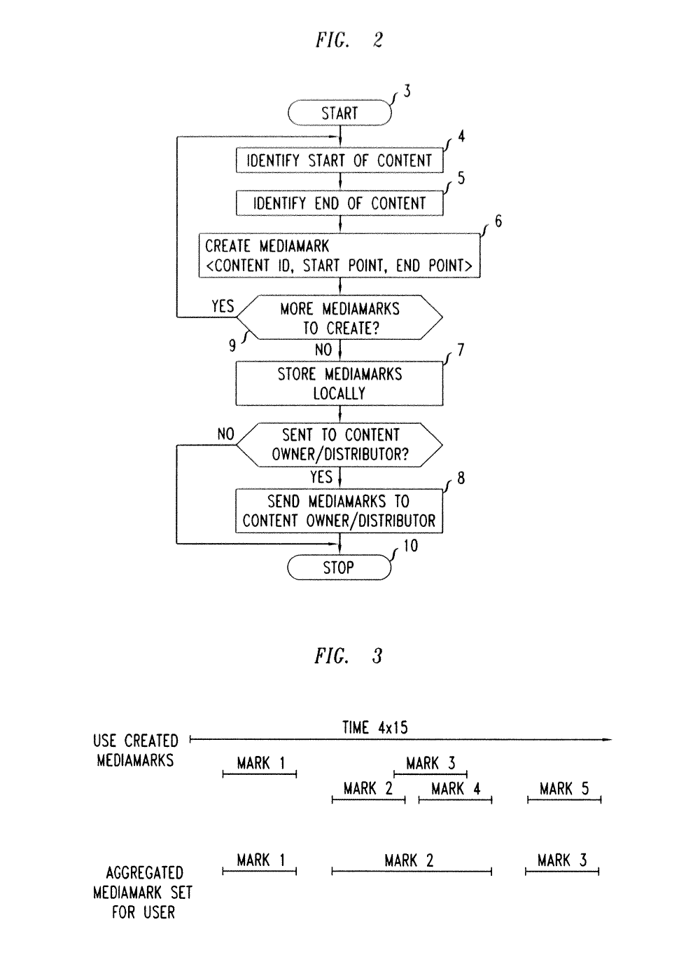

A group of media marks may be stored together and invoked at the same time. These media-marks could be potentially overlapping with each other, shown as user-created media marks in FIG. 3. The content provider, or the media player, then processes these media-marks into a set of non-overlapping discrete segments, shown in FIG. 3 as an aggregated media mark set, and streams, or requests, these segments one-by-one as above in a continuous fashion.

When multiple users identify their own media marks for the same media clip, there is likely to be some overlap among these media marks. For example, in a video clip of a soccer match, multiple users are likely to media mark a goal event or an injury event. While the start and stop times might differ slightly between the media marks of this event from these users, it is useful to identify and isolate distinct events from the media marks as well as identifying media marks that approximately denote the same events.

Interval-identification algorithms may be used to identify distinct media marks. However, to identify a media-mark that best fits similar media-marks, and also arrive at a popularity based ranking of these media-marks, a best-fit algorithm is employed instead so as to extract a ranking of these media-marks.

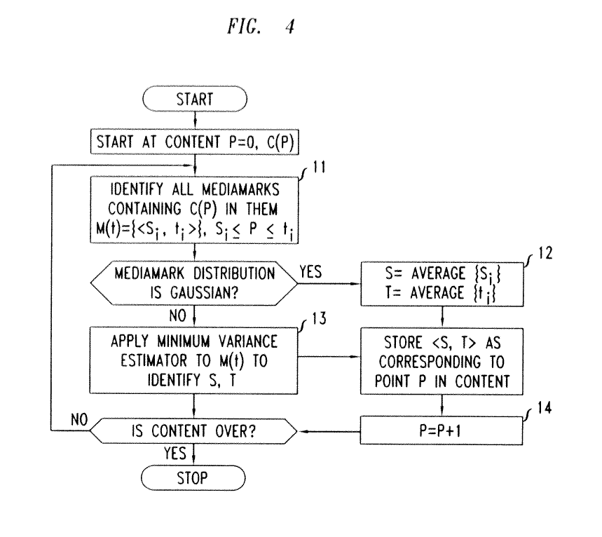

With reference to FIG. 4, given a media clip of length L, and a time instant P in the clip, there are given M media-marks containing P with the list of start and stop times {<s_i, t_i>}, such that s_i<═P<=t_i for all i=1, 2, . . . , M, shown at 11 in FIG. 4. For each such list of s_i (and t_i, respectively), the points S and T are identified that minimize the variance for this list.

This is derived using a minimum-variance unbiased estimator (MVLIF). For a large number of media marks of the same segment of the media clip, one may assume that the distribution of s_i and t_i are Gaussian, and therefore, the mean value of the s_i and t_i can be taken to be the values of S and T respectively, at 12. The new media-mark is now defined as <content-id, S, T>, and the number of samples used to derive the mean is taken as a ranking of this media-mark. If the distribution is non-Gaussian, a minimum variance estimator is applied at 13 to identify S, T. P is incremented by one at 14 and the process is repeated until all content is finished.

This ranking algorithm allows a content server or content provider to identify the highest-ranked media marks, that is, the most favored segments of a media clip, which can be used to present a better set of choices to users, especially when the rankings are viewed across multiple content-ids.

Provision may also be made to take into account user recommendations when ranking media marks. This may be done as a separate ranking or may be combined with that shown in FIG. 4, or some other ranking algorithm based on usage.

In one embodiment, the open source JW player is used, with the content provider/server operated locally using a XMoov-PHP script (http://stream.xmoov.com). The sample implementation uses video clips encoded in the Flash format, containing keyframes metadata. The following parameters are set on the XMoov-PHP script:

1. XMOOV_GET_FILE: the variable used for the video to play (that is, the file played with the JW Player).

2. XMOOV_GET_POSITION: the variable used for the start position (that is, the start position with JW Player).

The XMoov-PHP script may also be augmented additional variable:

3. XMOOV_GET_STOP_POSITION: the variable used for the stop position.

The XMoov-PHP script is modified to stop serving the file once the GET_STOP_POSITION point is reached. In addition, the JW player is modified to take a media mark file as input, and send the above three parameters to the content server running the XMoov-PHP script. The media-mark may be directly invoked via a URL (e.g., by calling xmoov.php?file=yourvideo.flv&position=10&stop-33 to play between 10 and 33 seconds).

The JW player is modified to add a media mark control, and use it as a toggle switch to record the start and stop of a media mark. One does not need to pause the media playback to record a media mark. When the button is pressed the first time, a start time is recorded, and when it is pressed the second time, a stop time is recorded, and a media mark file is created in the following format:

=yourvideo.flv

+start_time1
− stop_time1

+start_time2

− stop_time2
...

Multiple such lines can be part of a single media mark file for a single file, indicating multiple media-marks for a single file. The multiple media-marks can be overlapping.

The media marks may be used to highlight content that is not wanted by the user. For example, in a movie rated R, a user could media mark certain segments of the movie that children should not watch. When the movie is streamed/viewed with the media marks enabled, then these portions are skipped. This allows for a flexible parental control system with user-specific customization.

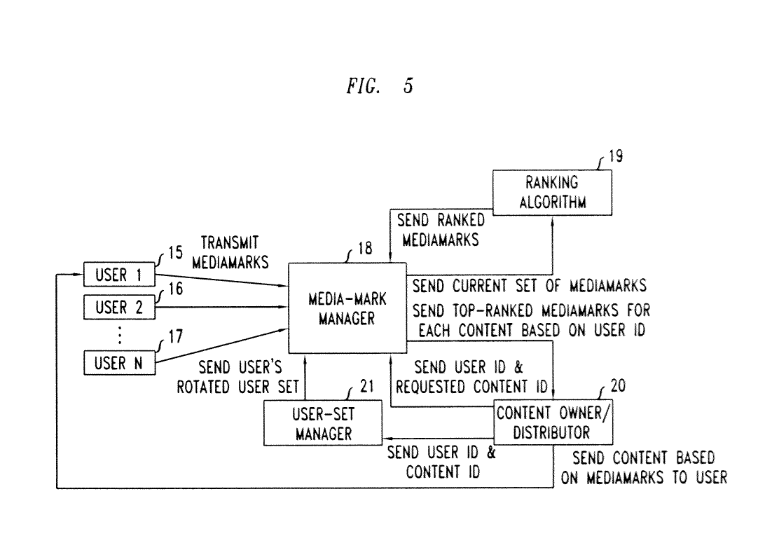

With reference to FIG. 5, in one embodiment, a plurality of users 15, 16, 17 transmit media marks to a media mark manager 18 which communicates with a ranking algorithm processor 19 to update the order of the ranked media marks as new ones are received by the media mark manager 18.

The media mark manager 18 also sends the top ranked media marks for each content based on user-id to the content owner/distributor 20. The content owner/distributor 20 sends user-id and requested content-id to the media mark manager 18. The content owner/distributor 20 also sends user-id and content-id to a user-set manager 21. The user-set manager 21 sends the user's related user set to the media mark manager 18. The user-set manager 21 may be omitted if data content is stored locally as then the content owner/distributor is the same as the user local hard disk.

The media mark manager 18 can also accept media marks from a user to be used in providing parental controls. The media mark manager 18 sends the information to the content owner/distributor 20 which then prevents the identified content from being streamed to the relevant user.

The functions of the various elements shown in the Figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

I claim:

1. A method for managing media content streamed to users via a network, including:
streaming a media content file via the network to a media player for playing the media content file;
when the media content file is played by a user, creating a media mark associated with the played media content file to identify a section of the played media content file which is of interest to the user, the media mark including a start indicator, a stop indicator and a content identifier; and
storing the media mark.

2. The method as claimed in claim 1 wherein the user operates a selector associated with the media player to create at least part of the media mark.

3. The method as claimed in claim 1 wherein at least part of the media mark is automatically created using information from user behavior as the user plays the media content file.

4. The method as claimed in claim 1 wherein a plurality of media marks are created for one media content file.

5. The method as claimed in claim 1 wherein at least one of the start indicator and the stop indicator is defined by the number of bytes from a given point of the media content file.

6. The method as claimed in claim 1 wherein at least one of the start indicator and the stop indicator is defined by a time duration from point of the media content file.

7. The method as claimed in claim 1 and including using the stored media mark to select the identified section of the media content file and streaming the selected section for playing by a user.

8. The method as claimed in claim 1 wherein the media content file is made available on a web page that is accessible to a plurality of users.

9. The method as claimed in claim 1 and ranking a plurality of media marks in a list.

10. The method as claimed in claim 9 wherein media marks are ranked on criteria that include at least one of: popularity; user recommendations; and information from the provider of the media content.

11. The method as claimed in 9 and including applying a best-fit ranking algorithm to a plurality of media marks to rank them by popularity with users.

12. The method as claimed in claim 1 including using the stored media mark to select a section of the media content file to be prevented from being made available to a user.

13. The method as claimed in claim 1 wherein the media player is at least one of: an application installed in user equipment; an application incorporated in a web browser used by the user to access content on the network; and an application included in a web page.

14. The method as claimed in claim 1 and including sending information about the stored media mark to the provider of the media content file.

15. The method as claimed in claim 1 and including associating the stored media mark with a user profile associated with the user.

16. The method as claimed in claim 1 and including using the stored media mark to select the identified section of the media content file to be included in a content control mechanism and preventing streaming of the selected section for playing by a user.

17. The method as claimed in claim 6 wherein the control mechanism is a parental control mechanism.

18. Apparatus for managing media content streamed to a user via a network, including: a media player application for playing media content files streamed via the network from a content provider; a selector for creating a media mark associated with a streamed media content file played by the media player, the media mark identifying a part of a media content file which is of interest to the user and the media mark including a start indicator, a stop indicator and a content identifier; and a store for storing the media mark at the network.
